(19) United States
(12) Patent Application Publication
(10) Pub. No.: US 2015/0227147 A1
(43) Pub. Date: Aug. 13, 2015

(54) LOAD DEPENDENT BIASING CELL FOR LOW DROPOUT REGULATOR

(71) Applicant: TEXAS INSTRUMENTS INCORPORATED, Dallas, TX (US)

(72) Inventors: VADIM V. IVANOV, Tucson, AZ (US); Ravinthiran Balasingam, Tucson, AZ (US)

(21) Appl. No.: 14/619,900

(22) Filed: Feb. 11, 2015

Related U.S. Application Data
(60) Provisional application No. 61/938,771, filed on Feb. 12, 2014.

(51) Int. Cl. G05F 1/575

(52) U.S. Cl. CPC G05F 1/575

(57) ABSTRACT

A circuit includes an error amplifier having a reference input that receives a reference voltage, a load feedback input that receives feedback from an output voltage, and a bias feedback input that receives a current to set a transconductance for the error amplifier. The error amplifier generates an error output signal to control an output voltage and load current of a low dropout (LDO) linear regulator based on a voltage difference between the load feedback input and the reference input. A bias adjuster monitors a load current generated by the LDO linear regulator and controls a bias current supplied to the bias feedback input of the error amplifier to control the transconductance of the error amplifier such that the transconductance of the error amplifier substantially tracks a transconductance of an output pass device supplying the output voltage and load current generated by the LDO linear regulator.

### CROSS-REFERENCE TO RELATED APPLICATION

This application claims the benefit of U.S. Provisional Patent Application 61/938,771 filed on 12 Feb. 2014, and entitled NON-LINEAR LOAD-DEPENDENT BIASING CELL FOR LOW DROP REGULATORS, the entirety of which is incorporated by reference herein.

### TECHNICAL FIELD

This disclosure relates to integrated circuits, and more particularly to a biasing circuit to facilitate stabilization of linear regulator circuits across varying load conditions.

### BACKGROUND

Low dropout (LDO) linear regulators usually are employed in systems that require a low-noise power source instead of a switching regulator that may disturb some systems. Low dropout refers to the difference between the input and output voltages that allow the regulator integrated circuit to regulate the output load voltage. That is, an LDO can regulate the output load voltage until its input and output approach each other at the dropout voltage. Ideally, the dropout voltage should be as low as possible to minimize power dissipation and maximize efficiency. An LDO voltage regulator operates in the linear region where its main circuit components include a series pass transistor (e.g., bipolar transistor or MOSFET), a differential error amplifier, and a precise voltage reference.

The error amplifier has a transconductance that forms a pole with capacitance of the series pass transistor. The series pass transistor of the LDO regulator circuit also has another transconductance value which forms another pole in the circuit with output load capacitance. The two poles from the error amplifier and the series pass transistor generally define the range of frequencies at which the LDO voltage regulator remains stable. The transconductance value for the series pass transistor however varies with load current which can cause stability problems in the LDO circuit by shifting the poles generated by the transconductance of the series pass transistor with respect to the transconductance of the error amplifier.

### SUMMARY

This disclosure relates to a load dependent biasing circuit for a low dropout linear regulator. In one example, a circuit includes an error amplifier having a reference input that receives a reference voltage, a load feedback input that receives feedback from an output voltage, and a bias feedback input that receives a current to set a transconductance for the error amplifier. The error amplifier generates an error output signal to control an output voltage and load current of a low dropout (LDO) linear regulator based on a voltage difference between the load feedback input and the reference input. A bias adjuster monitors a load current generated by the LDO linear regulator and controls a bias current supplied to the bias feedback input of the error amplifier to control the transconductance of the error amplifier such that the transconductance of the error amplifier substantially tracks a transconductance of an output pass device supplying the output voltage and load current generated by the LDO linear regulator.

In another example, a circuit includes a low dropout (LDO) linear regulator to generate a regulated output voltage and a load current. The LDO linear regulator includes an error amplifier having a reference input that receives a reference voltage, a load feedback input that receives feedback from the regulated output voltage, and a bias input that receives a current to set the transconductance for the error amplifier. The error amplifier generates an error output signal to control the regulated output voltage of the LDO linear regulator based on a voltage difference between the load feedback input and the reference input. The LDO linear regulator also includes a pass device having an input that receives the error output signal from the error amplifier and switches an input voltage to the regulated output voltage of the LDO linear regulator based on the error output signal. A bias adjuster controls a transconductance of the error amplifier such that the transconductance of the error amplifier substantially tracks a transconductance of the pass device supplying the regulated output voltage and load current generated by the LDO linear regulator. The bias adjuster includes a bias feedback circuit to monitor the load current generated by the LDO linear regulator and a driver circuit that supplies a bias current to the bias feedback input of the error amplifier based on the monitored load current from the bias feedback circuit.

In yet another example, a circuit includes a low dropout (LDO) linear regulator to generate a regulated output voltage and a load current. The LDO linear regulator includes an error amplifier having a reference input that receives a reference voltage, a load feedback input that receives feedback from the regulated output voltage, and a bias feedback input that receives a current to set a transconductance for the error amplifier. The error amplifier generates an error output signal to control the regulated output voltage of the LDO linear regulator based on a voltage difference between the load feedback input and the reference input. The LDO linear regulator includes a pass device having an input that receives the error output signal from the error amplifier and switches an input voltage to the regulated output voltage of the LDO linear regulator based on the error output signal. The LDO linear regulator also includes a sense device having an input that receives the error output signal from the error amplifier to supply a reference current proportional to the load current. A bias adjuster controls a transconductance of the error amplifier such that the transconductance of the error amplifier substantially tracks a transconductance of the pass device supplying the regulated output voltage and load current generated by the LDO linear regulator. The bias adjuster includes a bias feedback circuit to monitor the load current via the reference current supplied by the sense device. The bias adjuster also includes a diverter to divert a portion of the reference current from the bias feedback circuit. The diverter causes nonlinear operation of the bias adjuster by diverting a larger portion of the reference current as the load current increases. The bias circuit includes driver circuit that supplies a bias current to the bias feedback input of the error amplifier based on the monitored load current from the bias feedback circuit and a bias current limit to set a maximum amount of bias current supplied to the error amplifier based on the monitored load current.

### BRIEF DESCRIPTION OF THE DRAWINGS

FIG. 1 illustrates an example of a circuit that employs a load dependent biasing to facilitate stability in a low dropout linear regulator over a range of load conditions.

FIG. 2 illustrates an example of a bias adjuster circuit that provides load dependent biasing to facilitate stability in a low dropout linear regulator over a range of load conditions.

FIG. 3 illustrates an example of a low dropout linear regulator circuit.

FIG. 4 illustrates an example of a circuit that employs a load dependent biasing circuit having monitoring, feedback, and current limiting capabilities to facilitate stability in a low dropout linear regulator over a range of load conditions.

### DETAILED DESCRIPTION

This disclosure relates to a load dependent biasing circuit for a low dropout linear regulator. The biasing circuit dynamically compensates for output pole shifting that occurs as load current increases in an output pass device of a low dropout (LDO) linear regulator circuit which facilitates stability over a larger range of load current. Dynamic compensation includes monitoring the load current and adjusting the transconductance of an error amplifier that drives the output pass device such that the transconductance of the error amplifier substantially tracks the transconductance of the output pass device as load conditions change. Such tracking promotes stability in the regulator circuit by causing system poles associated with the respective error amplifier and output pass device to remain substantially in step with each other such that over a range of load currents, stability is maintained.

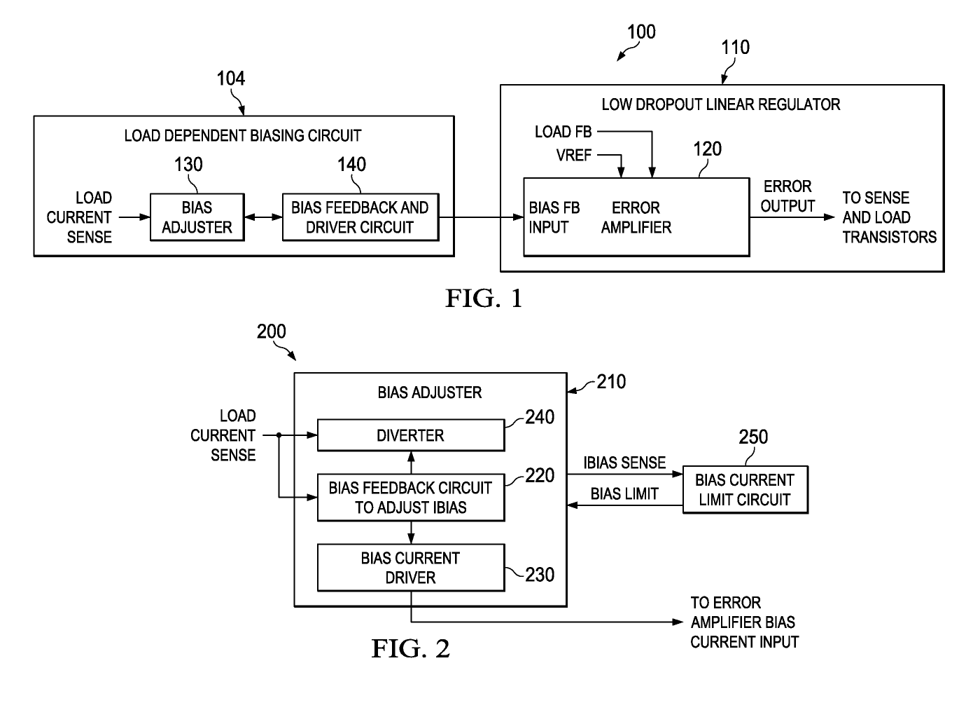

FIG. 1 illustrates an example of a circuit 100 that employs a load dependent biasing circuit 104 to facilitate stability in a low dropout (LDO) linear regulator 110 over a range of load conditions. As used herein, the term circuit can include a collection of active and/or passive elements that perform a circuit function such as an analog circuit or control circuit, for example. The term circuit can also include an integrated circuit where all the circuit elements are fabricated on a common substrate, for example. The LDO linear regulator 110 (also referred to as LDO) generates a regulated output voltage and a load current. The LDO 110 includes an error amplifier 120 having a reference input that receives a reference voltage VREF, a load feedback input that receives feedback LOAD FB from the regulated output voltage. A bias feedback input on the error amplifier 120 receives a current to set a transconductance for the error amplifier where the amount of current supplied to the input is generally proportional to the transconductance of the error amplifier.

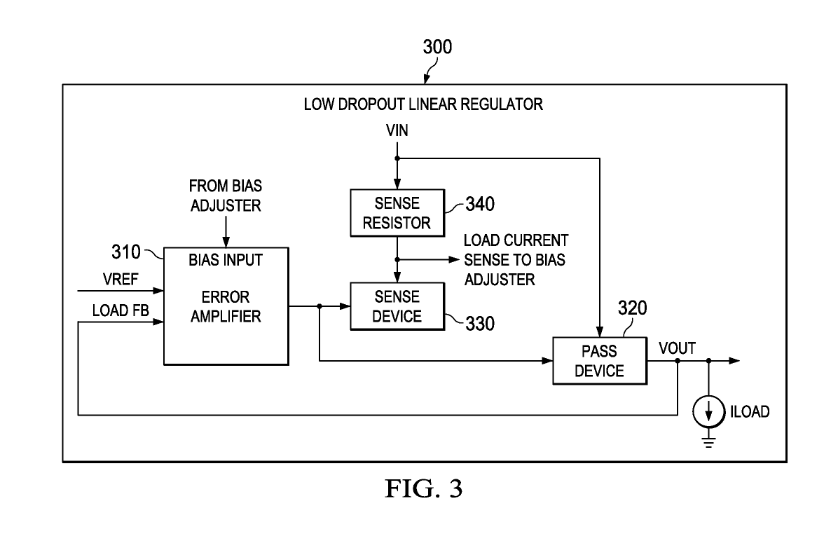

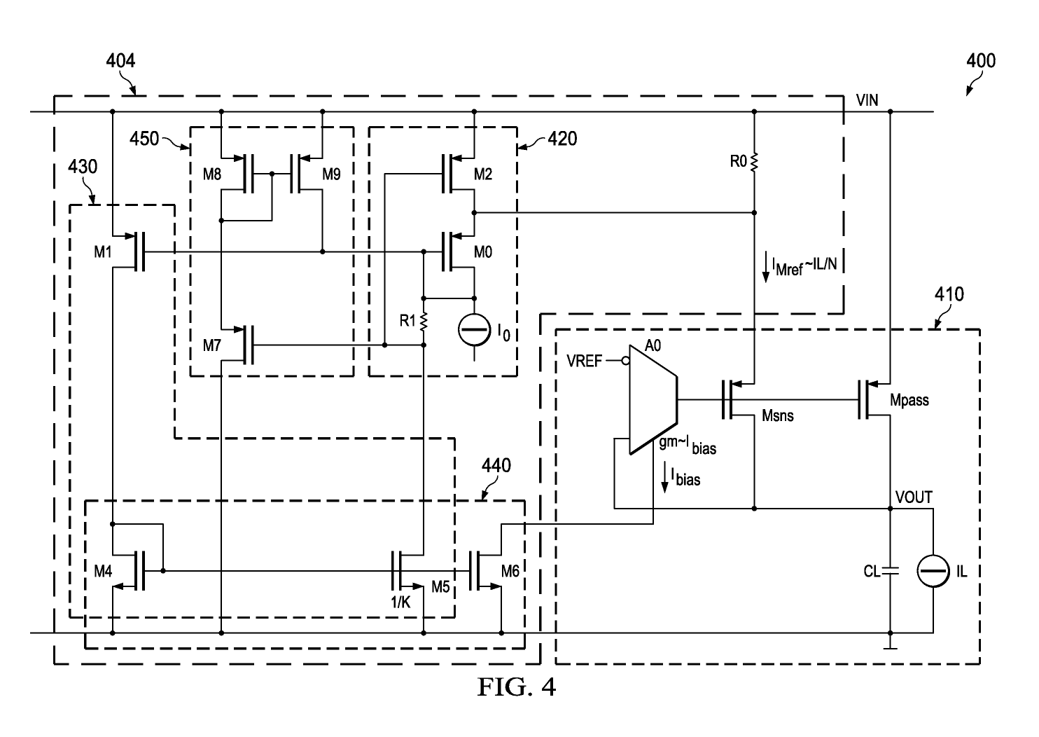

The error amplifier 120 generates an error output signal ERROR OUTPUT to control the regulated output voltage of the LDO linear regulator 110 based on a voltage difference between the load feedback input and the reference input. As will be illustrated and described below with respect to FIGS. 3 and 4, the LDO 110 includes a pass device having an input that receives the error output signal from the error amplifier 120 and switches an input voltage to the regulated output voltage of the LDO linear regulator by controlling the ON resistance of the pass device. The LDO 110 can also include a sense device having an input that receives the error output signal from the error amplifier 120 to supply a reference current proportional to the load current which can be utilized by other circuits to control the transconductance of the error amplifier.

A bias adjuster 130 in the load dependent biasing circuit 104 controls a transconductance of the error amplifier 120 such that the transconductance of the error amplifier substantially tracks a transconductance of the pass device (See examples of pass devices in FIGS. 3 and 4) supplying the regulated output voltage and load current generated by the LDO linear regulator 110. The bias adjuster 130 includes a bias feedback and driver circuit 140, where the bias feedback circuit monitors the load current via the reference current supplied by the sense device in the LDO 110. The bias feedback and driver circuit 140 also supplies a bias current to the bias feedback input of the error amplifier 120 based on the monitored load current from the feedback circuit. The bias adjuster 130 can include a diverter (See e.g., FIG. 2) to divert a portion of the reference current from the bias feedback circuit and driver circuit 140. The diverter causes nonlinear operation of the bias adjuster 140 by diverting a larger portion of the reference current as the load current increases. A bias current limit (not shown) can also be provided to set a maximum amount of bias current supplied to the error amplifier 120 based on the monitored load current.

From a stability point of view, the LDO 110 generally has at least 2 dominant poles—a first pole P1 is approximately equal to gm/Cp, where gm is the transconductance of the error amplifier 120 and CP is the capacitance at the controlling drive (base/gate) of the pass device. A second pole P2 is approximately equal to gm0/CL where CL is load capacitance and gm0 is the transconductance of the output pass device of the LDO 110 and is also a non-linear function of the load current. At small load currents gm0 is proportional to load current, then becomes proportional to the square root of the load current at higher load current values and becoming almost load-independent at larger currents. In order for the LDO 110 to be stable, one of the P1/P2 poles should be dominant. The P2 pole is changing widely with load current and if P1 is approximately equal to gm/CP and is constant, then providing stability at all load currents becomes a challenge. Generally, CP is chosen too large for most of the load current range, effectively slowing down the LDO 110. The load dependent biasing circuit 104 mitigates the stability problem by introducing non-linear biasing of the error amplifier 120 that causes it to change its transconductance gm with load approximately in the same manner as gm0 is changing with load current. The load dependent biasing circuit 104 also provides high speed operation and recovery from changes in load conditions. For instance, if during stable operation (constant load) value of the biasing affects gm and delays in biasing core do not modify stability, but during load changes, the input stage is skewed and thus, any dynamics/delays in biasing may effectively create additional poles and cause oscillations. The load dependent biasing circuit 104 mitigates creating additional poles by providing a rapid response time to such transient conditions.

FIG. 2 illustrates an example of a bias adjuster circuit 200 that provides load dependent biasing to facilitate stability in a low dropout linear regulator over a range of load conditions. A bias adjuster 210 controls the transconductance of an error amplifier such that the transconductance of the error amplifier substantially tracks a transconductance of a pass device supplying the regulated output voltage and load current generated by an LDO linear regulator as previously described. In this example, the bias adjuster 210 includes the bias feedback and driver circuits described previously with respect to FIG. 1.

A bias feedback circuit 220 monitors load current shown as LOAD CURRENT SENSE via a reference current supplied by a sense device (not shown). A bias driver circuit 230 supplies a bias current to the bias feedback input of the error amplifier (See e.g., FIG. 1) based on the monitored load current from the bias feedback circuit 220. A diverter 240 diverts a portion of the reference current from the bias feedback circuit 220. The diverter 240 causes nonlinear operation of the bias adjuster 210 by diverting a larger portion of the reference current as the load current increases. Nonlinear operations will be described below with respect to FIG. 4. A bias current limit circuit 250 monitors the bias current IBIAS generated by the bias adjuster 210 and sets a maximum amount of bias current supplied to the error amplifier based on the monitored load current (e.g., when a predetermined threshold is achieved, limit the bias current generated).

FIG. 3 illustrates an example of a low dropout linear regulator circuit 300. The low dropout (LDO) linear regulator 300 generates a regulated output voltage VOUT and a load current IL. The LDO 300 includes an error amplifier 310 having a reference input that receives a reference voltage VREF, a load feedback input that receives feedback LOAD FB from the regulated output voltage, and a bias feedback input that receives a current to set a transconductance for the error amplifier. The error amplifier 310 generates an error output signal to control the regulated output voltage of the LDO linear regulator 300 based on a voltage difference between the load feedback input and the reference input.

A pass device 320 (e.g., pass transistor) has an input that receives the error output signal from the error amplifier 310 and switches an input voltage VIN to the regulated output voltage VOUT of the LDO linear regulator 300 based on the error output signal. A sense device 330 (e.g., transistor having parameters correlated to the pass device) has an input that receives the error output signal from the error amplifier 310 to supply a reference current proportional to the load current. A sense resistor 340 can be in series with the sense device to sense the load current monitored by the sense device 330. As shown, current sensed from the sense resistor 340 and sense device 330 can be passed as a load current sense (e.g., reference current) to the bias adjuster circuits described herein.

FIG. 4 illustrates an example of a circuit 400 that employs a load dependent biasing circuit 404 having monitoring, feedback, and current limiting capabilities to facilitate stability in a low dropout linear regulator 410 over a range of load conditions. The low dropout (LDO) linear regulator 410 generates a regulated output voltage and a load current. An error amplifier A0 has a reference input that receives a reference voltage VREF, a load feedback input that receives feedback from the regulated output voltage VOUT, and a bias feedback input that receives a current Ibias to set a transconductance (gm) for the error amplifier. The error amplifier A0 generates an error output signal to control the regulated output voltage VOUT of the LDO linear regulator 410 based on a voltage difference between the load feedback input and the reference input. A pass device Mpass has an input that receives the error output signal from the error amplifier A0 and switches an input voltage to the regulated output voltage of the LDO linear regulator 410 based on the error output signal. A sense device Msns has an input that receives the error output signal from the error amplifier A0 to supply a reference current IMref proportional to the load current.

The load dependent biasing circuit 404 includes a bias adjuster 420 to control the transconductance of the error amplifier A0 such that the transconductance of the error amplifier substantially tracks a transconductance of the pass device Mpass supplying the regulated output voltage VOUT and load current IL generated by the LDO linear regulator 410. As shown, the bias adjuster 420 can include at least transistors M0 set-up with I0 and M2 placed across R0 which receives IMref from sense device Msns. The bias adjuster 420 can also include resistor R1 to cause M2 turn on harder as the sense load current IMref becomes higher. The load dependent biasing circuit 404 and/or bias adjuster 420 includes a feedback circuit 430 having M1, M4, and M5 to create current in M6 dependent on load current IL via the reference current supplied by the sense device Msns.

The bias adjuster 420 includes diverter M2 to divert a portion of the IMref reference current from R0 as it increases beyond preset level. This preset level is set by the I0 and R0 value and size of M0 and M2 and the feedback circuit 430. The diverter M2 causes nonlinear operation of the bias adjuster 420 by diverting a larger portion of the reference current IMref as the load current IL increases beyond preset value. A driver circuit 440 supplies a bias current Ibias to the bias feedback input of the error amplifier A0 based on the monitored load current from the feedback circuit 430. A bias current limit 450 includes transistor M7, M8, and M9 and sets a maximum amount of bias current supplied to the error amplifier A0 based on the monitored load current (by pulling M0/M1 gate high with M9 when M7 gate voltage dropped below a preset value).

The following now describes the interactions and nonlinear tracking operations of the various components in the circuit 400. In some instances, some of the components may serve more than one role (e.g., a transistor in the feedback circuit also operates in the driver circuit). The LDO 410 provides VOUT via current through its output device Mpass. A fraction of Mpass current flows through Msns, creating voltage drop across R0. The LDO 410 can have PMOS output devices for example (as shown) as well as NMOS (for NMOS source/drain should be reversed). The LDO error amplifier A0 is biased by Ibias from a nonlinear cell that includes M0, M1, M2, M4 and M5 which produces Ibias current in M6 to be some proportion of IL. This allows A0 transconductance gm in an approximation to be proportional to IL. Components of the non-linear biasing cell can be chosen as follows: R0<<R1, MI is substantially matching M0, M4 is substantially matching M6 and M5 with area ratio of 1/K where (K>>1 (e.g., 5 . . . 20)).

At zero load current IL, there is no voltage drop across R0 and Ibias=K*IM0 and approximately=current source I0 multiply by K. When IL increases, voltage across R0 also increases as well as current through M1, M4, M5, and M6. At small load current IL, Ibias is practically proportional to IL. Increasing of the current in M1, M4, and M5 also increases voltage drop across R1 through weak positive feedback provided via M0, M1, M4, and M5. As a result, M2 (also previously referred to as diverter) shorts a portion of the Msns current IMref. At large loads, most of the Msns current flows through M2. Feedback loop M7, M8, and M9 turns on when the voltage drop across R1 exceeds threshold Vth (e.g., VGS of M7), limiting maximum bias current supplied by M0, M1, M4, M5, and M6.

As IL increases, the larger the voltage drop across R0 becomes. It decreases voltage at the gate of M0 and more current starts to flow/divert through M2. Current through M2 is subtracted from current through R0 decreasing VR0, such that Ibias is less than proportional to IL, eventually becoming almost independent of IL. Bandwidth of this nonlinear circuit 404 is defined by I0 current source and parasitic capacitance at the gate of M0, so delay is very small and can be controlled by the I0 value. Due to weak inversion operation of transistors in the circuit 400, it is noted that the sensed or reference current supplied by Msns and flowing through R0 can be described by the equation IMref is approximately=to IL/N, where N is a sensor ratio defined by area W/L ratio between Mpass and Msns.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A circuit comprising:
an error amplifier having a reference input that receives a reference voltage, a load feedback input that receives feedback from an output voltage, and a bias feedback input that receives a current to set a transconductance for the error amplifier, wherein the error amplifier generates an error output signal to control an output voltage and load current of a low dropout (LDO) linear regulator based on a voltage difference between the load feedback input and the reference input; and
a bias adjuster to monitor a load current generated by the LDO linear regulator and to control a bias current supplied to the bias feedback input of the error amplifier to control the transconductance of the error amplifier such that the transconductance of the error amplifier substantially tracks a transconductance of an output pass device supplying the output voltage and load current generated by the LDO linear regulator.

2. The circuit of claim 1, wherein the bias adjuster generates the bias current in a linear proportion to the load current at lower values of the load current and generates the bias current in a nonlinear proportion to the load current at higher values of the load current to the control the transconductance of the error amplifier in a nonlinear manner with respect to the nonlinear transconductance changes of the output pass device.

3. The circuit of claim 2, further comprising a bias feedback circuit to monitor the load current via a reference current representing the load current supplied by a sense device.

4. The circuit of claim 3, further comprising a driver circuit that supplies a bias current to the bias feedback input of the error amplifier based on the monitored load current from the feedback circuit.

5. The circuit of claim 3, further comprising a diverter to divert a portion of the reference current from the bias feedback circuit, wherein the diverter causes nonlinear operation of the bias adjuster by diverting a larger portion of the reference current as the load current increases.

6. The circuit of claim 3, further comprising a current source that sets the bias current in the bias adjuster.

7. The circuit of claim 3, further comprising a bias current limit to set a maximum amount of bias current supplied to the error amplifier based on the monitored load current.

8. The circuit of claim 7, wherein the maximum amount of bias current is set via a predetermined threshold in the bias current limit.

9. The circuit of claim 1, further comprising a sense device to sense a reference current from the load current in accordance with the output pass device.

10. The circuit of claim 9, wherein the reference current is supplied by a sense transistor and is approximately equal to the load current/N, where N is a sensor ratio defined by area W/L ratio between the sense device and the output pass device.

11. A circuit comprising:
a low dropout (LDO) linear regulator to generate a regulated output voltage and a load current, the LDO linear regulator comprising:
an error amplifier having a reference input that receives a reference voltage, a load feedback input that receives feedback from the regulated output voltage, and a bias feedback input that receives a current to set a transconductance for the error amplifier, wherein the error amplifier generates an error output signal to control the regulated output voltage of the LDO linear regulator based on a voltage difference between the load feedback input and the reference input; and
a pass device having an input that receives the error output signal from the error amplifier and switches an input voltage to the regulated output voltage of the LDO linear regulator based on the error output signal;
a bias adjuster to control the transconductance of the error amplifier such that the transconductance of the error amplifier substantially tracks a transconductance of the pass device supplying the regulated output voltage and load current generated by the LDO linear regulator; the bias adjuster comprising:
a bias feedback circuit to monitor the load current generated by the LDO linear regulator; and
a driver circuit that supplies a bias current to the bias feedback input of the error amplifier based on the monitored load current from the feedback circuit.

12. The circuit of claim 11, wherein the bias adjuster generates the bias current in a linear proportion to the load current at lower values of the load current and generates the bias current in a nonlinear proportion to the load current at higher values of the load current to the control the transconductance of the error amplifier in a nonlinear manner with respect to the nonlinear transconductance changes of the output pass device.

13. The circuit of claim 12, further comprising a diverter to divert a portion of the reference current from the bias feedback circuit, wherein the diverter causes nonlinear operation of the bias adjuster by diverting a larger portion of the reference current as the load current increases.

14. The circuit of claim 13, further comprising a current source that sets the bias current in the bias adjuster.

15. The circuit of claim 11, further comprising a bias current limit to set a maximum amount of bias current supplied to the error amplifier based on the monitored load current.

16. The circuit of claim 15, wherein the maximum amount of bias current is set via a predetermined threshold voltage in the bias current limit.

17. The circuit of claim 11, further comprising a sense device to sense a reference current from the load current in accordance with the output pass device.

18. The circuit of claim 17, wherein the reference current is supplied by a sense transistor and is approximately equal to the load current/N, where N is a sensor ratio defined by area W/L ratio between the sense device and the output pass device.

19. A circuit comprising:
a low dropout (LDO) linear regulator to generate a regulated output voltage and a load current, the LDO linear regulator comprising:
an error amplifier having a reference input that receives a reference voltage, a load feedback input that receives feedback from the regulated output voltage, and a bias feedback input that receives a current to set a transconductance for the error amplifier, wherein the error amplifier generates an error output signal to control the regulated output voltage of the LDO linear regulator based on a voltage difference between the load feedback input and the reference input;
a pass device having an input that receives the error output signal from the error amplifier and switches an input voltage to the regulated output voltage of the LDO linear regulator based on the error output signal;
a sense device having an input that receives the error output signal from the error amplifier to supply a reference current proportional to the load current;
a bias adjuster to control the transconductance of the error amplifier such that the transconductance of the error amplifier substantially tracks a transconductance of the pass device supplying the regulated output voltage and load current generated by the LDO linear regulator; the bias adjuster comprising:
a bias feedback circuit to monitor the load current via the reference current supplied by the sense device;
a diverter to divert a portion of the reference current from the feedback circuit, wherein the diverter causes nonlinear operation of the bias adjuster by diverting a larger portion of the reference current as the load current increases;
a driver circuit that supplies a bias current to the bias feedback input of the error amplifier based on the monitored load current from the feedback circuit; and
a bias current limit to set a maximum amount of bias current supplied to the error amplifier based on the monitored load current.

20. The circuit of claim 19, wherein the bias adjuster generates the bias current in a linear proportion to the load current at lower values of the load current and generates the bias current in a nonlinear proportion to the load current at higher values of the load current to the control the transconductance of the error amplifier in a nonlinear manner with respect to the nonlinear transconductance changes of the output pass device.
